(19) United States
(12) Patent Application Publication
(10) Pub. No.: US 2003/0149891 A1
(43) Pub. Date: Aug. 7, 2003

(54) Method and device for providing network security by causing collisions

(76) Inventor: Brant D. Thomsen, Sandy, UT (US)

Correspondence Address: WAGNER, MURABITO & HAO LLP, Third Floor, Two North Market Street, San Jose, CA, 95113, US

(21) Appl. No.: 10/061,376

(22) Filed: Feb. 1, 2002

(51) Int. Cl. G06F 11/30

(52) U.S. Cl. 713/201

(57) ABSTRACT

A method for providing security in a computing network. When a security node receives a packet broadcast in a segment of the network, it compares an address in the packet with a stored list of addresses to determine if the packet is associated with an untrusted device. The address may be a source or destination address in packet. If the security node determines that an unauthorized packet is being broadcast, it broadcasts a garbage packet while the unauthorized packet is being broadcast. This causes a collision and the nodes in the segment will ignore both packets. The security node may have stored thereon a list of authorized or unauthorized addresses (e.g., medium access control addresses), which it references whenever it detects a packet being broadcast.

### TECHNICAL FIELD

The present invention generally pertains to the field of networked computers. More particularly, the present invention is related to a method for providing security by restricting access to a network.

### BACKGROUND ART

Modern computing networks allow great benefits by sharing information and computing resources. However, such networking presents several security issues. One such security issue is detecting that the security of a network has been potentially compromised by unauthorized access. Detection of such potential security compromise requires the detection of access to the computing network by entities lacking authorization to have such access.

Related to this issue of unauthorized access is a second security issue, which is preventing an unauthorized device, e.g., a computing and/or communications device wielded by an unauthorized entity, from actually getting into the network. Also, related to this second security issue is preventing such an unauthorized device that does penetrate the network from learning about the existence of network resources.

Further, related to the foregoing security issues is another: if an unauthorized device is detected, e.g., that its access to a network has not been prevented, the portion of the network to which it has access must at least be restricted. This can delimit the mischief the unauthorized device can cause.

Conventionally, two principal methods moderate access to a network. The first of these methods requires some type of identity authentication process for the entity attempting to access the network, effectively restricting network access to authorized persons. An example of this first method is the IEEE 802.1x Protocol, discussed in more detail below, wherein a satisfactory authentication interaction is required prior to any exposure of the network to the entity attempting to access it.

The second such method is the deployment of techniques to detect intrusion. An example of this second method is an Intrusion Detection System (IDS). An IDS employs software that detects unauthorized entrance to a network and/or to computer system components thereof. A network IDS (NIDS) supports multiple hosts. Typically, an IDS looks for signatures of known attempts to breach security as a signal of a possible security violation. An IDS may also look for deviations of normal routines as indications of a possible intrusion or other network security violation.

Referring to FIG. 1, most networks 120 have firewalls 135 to prevent unauthorized users to directly access the network 120 from outside the network 120 (e.g., from the Internet 140). The firewall 135 may implemented in software on a computer, in a router, in a stand-alone firewall box, etc. The network 120 may also have a Virtual Private Network (VPN) gateway 130. Virtual Private Networks enjoy the security of a private network via access control and encryption. In the system of FIG. 1, all traffic from the Internet 140 goes through either the firewall 135 or the VPN gateway 130. Thus, a certain measure of protection is provided for those paths.

However, the firewall 135 and VPN gateway 130 will not detect or prevent unauthorized access from within the network 120, which may be a wireline network 120a or a wireless network 120b. For example, with a typical Ethernet network, anyone that has physical access to a hardware port 128 on the network can attach electronic device 125 such as a laptop computer to gain access to the network 120, e.g., by using a Network Interface Card (NIC).

Unauthorized access can also be gained by attaching to a wireless Local Area Network (LAN) Point 127 attached to the network 120. Also, the firewall 135 may be avoided if a remote device connects to the network 120 using dial-up (RAS) 132 or even the Virtual Private Network gateway 130, thus achieving direct access the network 120. For example, an employee having a username and a password may use a dial-up connection to obtain access to a corporate network.

Furthermore, with a typical Ethernet network, any device 125 connected to the network 120 can communicate with any other device 125 on that segment 145 of the network 120. A router 137 or switch may be programmed block packets originating at a given device 125 from leaving the segment 145. However, this conventional method will not prevent the unauthorized device 125 from communicating with devices 125 on its own segment 145.

One conventional method for providing security for a network is described in the IEEE 802.1x specification. Therein is described a hardware block technique as illustrated in FIG. 2. When a client device 125 first connects to the network, the client device 125 is only allowed to communicate with the authentication server 121. A hardware switch 131 prevents the client device 125 from accessing the full network 141. After the client device 125 authenticates with the authentication server 121, the hardware switch 131 allows the client device 125 to have access to the network 141.

Another conventional method for promoting network security also involves a degree of server control. In this scheme, a network is constituted by a centralized server and peripheral entities, interconnected via their individual NICs. A peripheral entity intercommunicates with the centralized server via its NIC. The centralized server promulgates intercommunication policies to the NIC, instructing its entity as to whether intercommunication between that entity and certain Internet Protocol (IP) addresses is permissible or forbidden.

The intercommunication policies promulgated by the centralized server may also instruct an entity to permit or to prohibit certain intercommunication related events. Examples of such events include allowing its NIC to go into a promiscuous mode, and allowing the generation of fake responses or other signals to polling and other network queries, in order to keep a session active and prevent termination, such as by timeouts.

The foregoing conventional methods of moderating network access are problematic for at least two major reasons. In the first place, requiring authentication procedure compliance to gain network access is not fool proof. “Spoofing,” e.g., faking the sending address of a data transmission in order to “authenticate without authorization,” if successful, may expose even a seemingly secure network to intrusion. Spoofing will be discussed in somewhat greater detail below.

Further, the “seemingly secure” nature of the network in such an instance weaves an obviously false sense of security. This false sense of security has its own risks, because great amounts of mischief may occur under its camouflage. Such mischief may perhaps occur in a manner and on an order unlikely in a patently unsecure system, wherein network participants would more probably know to take appropriate precautions.

Secondly, conventional methods of detecting intrusion into secured networks typically seek effects there caused by the presence of and/or actions there taken by unauthorized entities who have gained access thereto. In many cases, this amounts to nothing more than internal damage assessment. It thus provides no ability to prevent the intrusion or resultant damage, or even to detect such intrusion in real time or near real time.

Another difficulty with conventional network security lies in how to detect unauthorized entry into certain network areas by an entity authorized to access other areas, and to prevent such unauthorized access. Once an entity has access to a portion of a network to which it is authorized for such access, problems may occur when that entity spoofs to gain access to other network areas normally off limits, e.g., restricted to it. However, it has proven difficult to establish conventional networking regimes that effectuate segregation of a network into areas differentially accessible to various entities.

On an exemplary corporate LAN for instance, an entity authorized for access to engineering may lack authority to access accounting, legal, personnel, marketing, and executive areas. Another entity thereon may be authorized access to accounting and personnel, but engineering, legal, and various other areas may be restricted to it. An entity wielded by a senior executive may, of course, require access to most, if not all, of the areas on the exemplary LAN.

Spoofing

Spoofing for intrusive access to a network and/or other circumvention or defeat of network security protocols may proceed by any of a number of different schemes. These schemes may be executed singly or in combination. Examples of more problematic spoofing schemes include the following.

False IP Addresses

As discussed above, an entity intruding upon a network may initiate spoofing. Spoofing may be effectuated in a number of ways. Exemplary methods by which spoofing has successfully led to intrusive network security violations include transmitting data packets purporting to originate from another entity, e.g., an entity authorized for access to the network being intruded upon. Spoofing by this method, an intrusive entity transmits identification information among the spoofing data packets which falsely claim the identity of (e.g., identifies the intrusive spoofing entity to the network by) the Internet Protocol (IP) address of the NIC of an authorized entity.

Duplicating MAC Addresses

Similarly, an intrusive entity may engage in spoofing by transmitting data packets duplicating the media access control (MAC) address of an authorized entity. A MAC address is a singular serial number preset hard coded, e.g., burned into NICs, such as Ethernet and Token Ring adapters and serving to uniquely identify that NIC from all others. The MAC address identifier is a participant in MAC layer functionality network adapters, including IEEE 802.1x and other IEEE 802 protocols, controlling access to the physical transmission media of a network.

This form of spoofing may be carried out in an attempt to gain access to network addresses that check MAC addresses. Such spoofing may also be conducted in an attempt to intercept network traffic intended only for the NIC that legitimately holds that MAC address.

Importantly, although each NIC does have a unique MAC Address burned into it, this preset MAC Address is effectively that NIC's default MAC Address. It is possible for the driver software controlling that NIC to override this burned in MAC Address by instructing the NIC to adopt a different MAC Address for use, similar or even identical in configuration to the burned-in MAC Address, but differing in some identifyingly unique specific. This possibility is what actually effectuates spoofing in this particular manner. Further, some NICs may allow the burned in MAC Address to actually be changed, such as by having new information burned into them, thus overwriting the original burned in MAC Address. This also effectuates this mode of spoofing.

Changing MAC Addresses

In the case of an entity whose MAC address rightfully gains it access to a certain portion of a network, spoofing may be attempted to intrude upon restricted areas of the network. Spoofing in such cases has been conducted by the entity admitted to the unrestricted area, then transmitting data packets purporting to have the MAC address of another entity, e.g., one permitted access to the restricted area.

Static Adoption of IP Addresses

Typically, entities seeking access to a network initiate a communicative interaction with a dynamic host configuration protocol (DHCP) server, wherein among other actions, the entity seeking access requests assignment of a network-specific IP address by that server. However, an intrusive entity may engage in spoofing by attempting to circumvent this assignment. Spoofing by this method, the intrusive entity adopts a static, e.g., unchanging, effectively permanent IP address, instead of requesting one from the network's DHCP server.

Inappropriate Non-Local IP Addresses

Networks are often segregated into localized sub-networks (e.g., subnets). Typically, IP addresses of entities within a particular subnet conform to some local configuration standard, identifying them as local IP addresses and assigning them an access level. These addresses would be assigned by a switch or a router respectively switching or routing data packets from those entities onto that particular subnet. However, an intrusive entity may engage in spoofing by attempting to circumvent this convention. Such spoofing includes the transmission of data packets having IP addresses inappropriate to that subnet, e.g., foreign to the configuration standard IP address identifier typically assigned by the routers and/or switches serving that subnet.

Inappropriate Routing/Switching Pathways

Segregated into local subnets, local network data traffic follows corresponding routing and switching pathways, which are also appropriate to the configuration of the local subnets. However, an intrusive entity may engage in spoofing by attempting to obscure, misrepresent, and/or otherwise obfuscate the path its data packets take. Such spoofing includes the transmission of data packets having IP addresses inappropriate to the pathway data packets would normally take on a particular subnet and possibly foreign to the configuration of that subnet.

The foregoing examples are not meant to be an exhaustive list of spoofing schemes used to intrude into secured networks or otherwise breach network security measures. They represent some of the more problematic of such spoofing schemes. However, in as much as such intrusions and other security breaches enabled by such spoofing continue to be problematic to networking and costly to users of networks, countermeasures to such schemes are sought. Such countermeasures should be capable of implementation without gross revamping of network architecture or burdening network accessibility by legitimate authorized entities.

Thus, a need has arisen for a way to prevent unauthorized access to a network. A still further need exists for a method that works in a network which is vulnerable to attack from a direct connection. An even further need exists for a method that provides security for devices that are on the same segment of a network.

### SUMMARY

Embodiments of the present invention provide a way to prevent and restrict unauthorized access to a network. Embodiments provide a method that works in a network which is vulnerable to attack from a direct connection. Embodiments provide a method that provides security for devices that are on the same segment of a network.

A method for providing security in a computing network is disclosed. In one embodiment, whenever a security node receives a packet broadcast in a segment of the network, it compares an address in the packet with a stored list of addresses to determine if the packet is associated with an untrusted device. The address may be a source or destination address in packet. If the security node determines that an unauthorized packet is being broadcast, it broadcasts a garbage packet while the unauthorized packet is being broadcast. This causes a collision and the nodes in the segment of the network will ignore both packets. The security node may have stored thereon a list of authorized or unauthorized addresses (e.g., medium access control addresses), which it references whenever it detects a packet being broadcast.

The security node may re-broadcast the garbage packet if the unauthorized packet is detected again. Furthermore, the security node may transmit a warning message upon detecting the unauthorized packet.

Another embodiment provides for a device for providing security in a network by causing collisions. The device has memory for storing a list of untrusted or trusted addresses. The device is operable to compare the list of addresses with an address in each received packet, to determine if a packet is a security risk. The device is also configured to broadcast a packet to cause a collision with an unauthorized packet being broadcast to or from an untrusted device.

These and other advantages of the present invention will no doubt become obvious to those of ordinary skill in the art after having read the following detailed description of the preferred embodiments which are illustrated in the various drawing figures.

### BRIEF DESCRIPTION OF THE DRAWINGS

FIG. 1 is a diagram of a conventional network illustrating security problems.

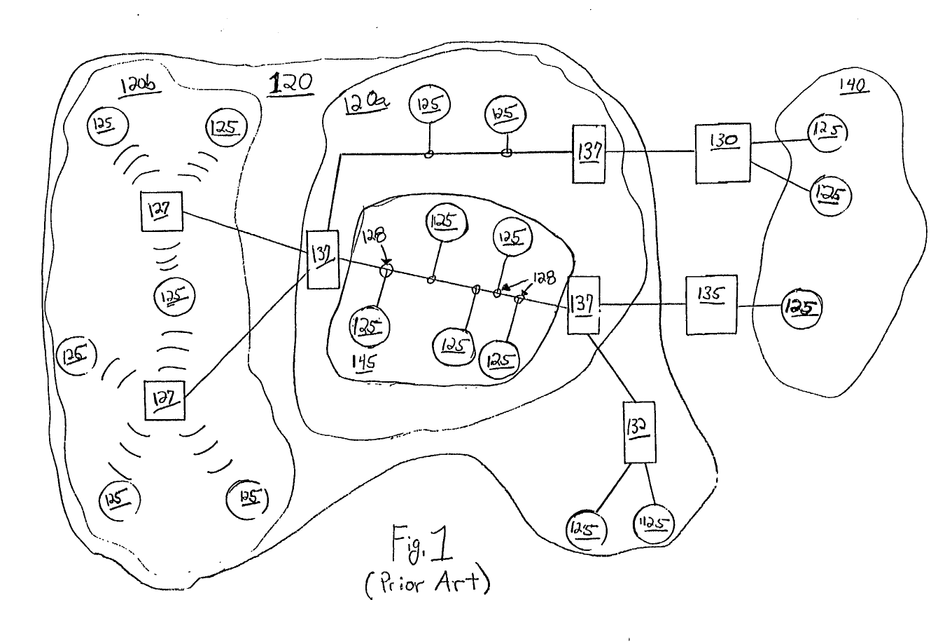

FIG. 2 is a diagram of a conventional technique to provide security for a network using a physical switch.

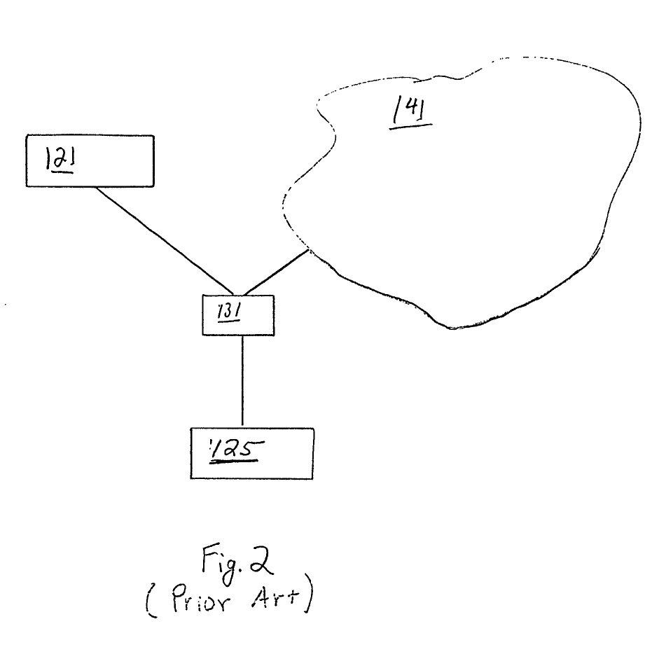

FIG. 3 is a diagram of a network with a node for broadcasting packet in a segment of the network to cause a collision to provide security, according to embodiments of the present invention.

FIG. 4 is a flowchart illustrating steps of a process of broadcasting a packet to cause a collision to provide security, according to embodiments of the present invention.

FIG. 5A and FIG. 5B are diagrams illustrating timelines of packets broadcast by a security node and by an unauthorized node, according to embodiments of the present invention.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

### Method and Device for Providing Network Security by Causing Collisions

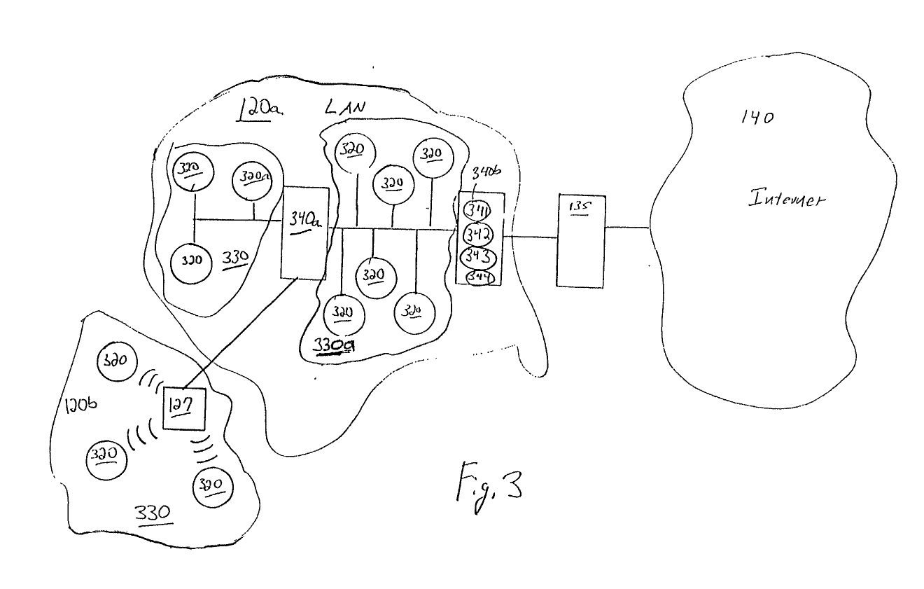

Embodiments of the present invention provide for a method and device to provide network security by causing a collision between an unauthorized packet and one that is generated by a security node. FIG. 3 illustrates an exemplary network 120 in which embodiments of the present invention may be practiced. An embodiment of the present invention may be practiced in a segment 330 of a network 120, which may be, for example an Ethernet LAN. However, the present invention is not limited to an Ethernet. The network 120 may support either TCP/IP or non-TCP/IP traffic. The segment 330 of FIG. 3 may be described as a segment 330 of a larger network 120. FIG. 3 shows the LAN 120 connected to the Internet 140 via a firewall 135, although these elements are not required. The LAN 120 may be wireline 120a or wireless 120b. In one embodiment, the segment 330 is a segment of a wireless LAN 120b. As shown, the wireless access point 127 connects to the wireline LAN 120b via security node 340a. It will be understood that a wireless access point 127 may function as a security node 340, if desired.

The segment 330 may have one or more nodes which function as a security node 340. The security node 340 may be a device, such as, for example, a router, switch, or the like. The security node 340 may be operable to control the flow of packets into and out of the segment 330. Thus, the security node 340 may prevent unauthorized traffic from entering or leaving the segment 330. For example, if a node 320 which is outside of the segment 330a (e.g., node 320a) broadcasts a packet, the security node 340a may block that packet from entering the segment 330a. However, if a node 320 in the segment 330a broadcasts a packet, any other node 320 in that segment 330a may receive that packet. Throughout this application the term segment 330 may be used to describe the portion of a larger network 120 into and out of which traffic flow may be controlled. Within the segment 330, nodes 320 are able to have access to all authorized packets. However, the present invention is not limited to being practiced within a segment 330 of a larger network 120.

According to convention, nodes 320 listen to packets which are intended for them. However, if an unauthorized node 320 broadcasts a packet within the segment 330 to another node 320 (authorized or unauthorized) in the segment 330, embodiments prevent the packet from being received. This is in contrast to conventional methods which allow such unauthorized broadcasts within a segment 330 to be received.

In other cases, an unauthorized node 320 may be the intended recipient of a packet. Embodiments prevent such a packet from being received by the unauthorized node 320. Again, this is in contrast to conventional techniques that may allow a packet to be addressed to an unauthorized node 320.

The segment may comprise any number of nodes 320, which may connect to the network 120 in a variety of ways such as, for example, a network interface connection (NIC), a PCMCIA card, a wireless LAN access point 127, a network adapter, an ASIC or other infrastructure within the device 320, etc. Embodiments of the present invention may be suitable to provide security in a segment of a wireless LAN 120b. For example, while data encryption may be used to provide a type of security for the nodes 320 in the wireless LAN 120b, embodiments prevent packets from being received in the wireless LAN 120b when a node is engaged in suspicious behavior.

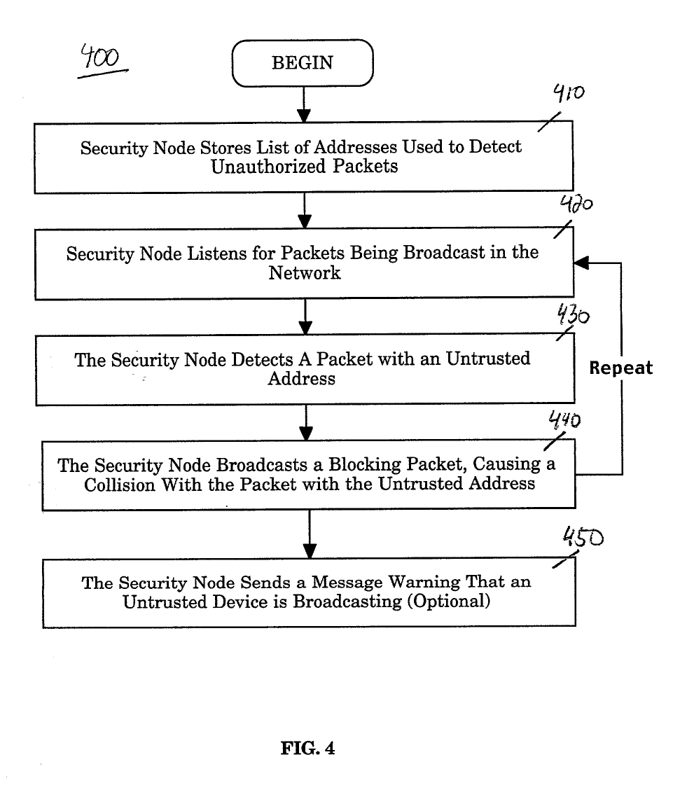

Referring now to Process 400 of FIG. 4, embodiments provide a method of preventing unauthorized broadcasts in a segment 330 by causing packet collisions. In step 410, a security node 340 adds to or builds from scratch a list of addresses, which it uses to detect unauthorized packet broadcasts in the segment 330. For example, the security node 340 may receive such a list or update to the list from, for example, an authentication server (not shown). The list may be those of authorized addresses or unauthorized addresses. The address may be a hardware address of the node 320 which is either sending or receiving the packet. In one embodiment, the address is a medium control address (MAC) address. However, the present invention is not limited to using the node's MAC address.

The list may be compiled in any suitable fashion. For example, nodes 320 may authenticate themselves with an authentication server, which adds an address of the node 320 to a listed of trusted addresses. This list may then be sent to the security node 340. Alternatively, the security node 340 itself may authenticate nodes 320 in the segment 330. A method of compiling a list of trusted addresses in a network 120 is described in co-pending U.S. patent application Ser. No. ______, filed Jan. 28, 2002, entitled, “Method For Managing Network Access,” by Thomsen, attorney docket number 3COM-3662.MCD.US.P and assigned to the assignee of the present invention and incorporated herein by reference.

Alternatively, the security node 340 may have a list of unauthorized addresses, which may be compiled in any suitable fashion. For example, one or more nodes 320 in the network (within or outside the segment 330) may compile a list or lists of unauthorized address. Any suitable technique may be used to determine that a node 320 is untrusted and that therefore its hardware address should be added to this list. This list may then be transferred to the security node 340. Periodically, the security node 340 may receive updates. Additionally, the security node 340 itself may detect unauthorized or untrusted nodes 320 and add their addresses to its list of unauthorized addresses. A method of detecting suspicious or inappropriate behavior and compiling a list of associated untrusted addresses is described in co-pending U.S. patent application Ser. No. ______, filed Jan. 18, 2002, entitled, “A Method For Detecting Unauthorized Network Access By Monitoring For Possible Indicators Of Spoofing Activity,” by Thomsen, attorney docket number 3COM-3661.MCD.US.P and assigned to the assignee of the present invention and incorporated herein by reference. Another method of detecting suspicious or inappropriate behavior and compiling a list of associated untrusted addresses is described in co-pending U.S. patent application Ser. No. ______, filed Jan. 31, 2002, entitled, “A Method For Detecting Unauthorized Network Access By Having A NIC Monitor For Packets Purporting To Be From Itself,” by Thomsen, attorney docket number 3COM-3660.MCD.US.P and assigned to the assignee of the present invention and incorporated herein by reference. However, the present invention is not limited to these techniques.

Referring again to Process 400 of FIG. 4, after the security node 340 has established a list of address, it listens for packets being broadcast in the segment 330, in step 420. It will be understood that the security node 340 may check every packet which it receives that was broadcast from within the segment. Packets from outside the segment 330 to be transferred into the segment 330 may be processed by another algorithm to filter unauthorized communications.

In step 430, the security node 340 then detects that a packet with an unauthorized address is being broadcast in the segment 330. The security node 340 may detect an unauthorized packet by reading an address in the packet and comparing it with a list of addresses stored on the security node 340. For example, the packet may have a source address and a destination address, which may be hardware addresses. In one embodiment, these are MAC addresses. The security node 340 may check the source address, the destination address or both. Thus, whether the packet is being sent to or from an unauthorized node 320, the security node 340 may detect an unauthorized broadcast. Embodiments are suitable to be used in a network 120 which supports unicast, multicast, and broadcast modes or any combination thereof. Throughout this application the term broadcast may be defined as a node 320 transmitting (e.g., broadcasting) a packet regardless of whether the mode is unicast, multicast, or broadcast mode. Thus, it will be understood that even if the packet specifies a single destination hardware address (e.g., unicast mode), the node 320 may be defined to be broadcasting the packet.

In step 440 of Process 400, the security node 340 may broadcasts a garbage packet while the unauthorized packet is still being broadcast. The security node 340 may begin broadcasting the garbage packet as soon as the unauthorized packet is detected. In this fashion, a collision will be caused between the garbage packet and the unauthorized packet. As those of ordinary skill in the art will understand, this will cause the data received by a node to be corrupted and node will discard the data. For example, the collision may be detected by a Cyclic Redundancy Check (CRC) falling at the receiving node. Referring again to FIG. 3, the security node 340 may have memory 341 to store a list of addresses, detection logic 342 for detecting a packet that is a security risk, logic 343 to transmit the garbage packet, and logic 344 to transmit a warning message.

Thus, the various nodes 320 in the segment 330 may be operable to detect such a collision. As those of ordinary skill in the art will understand, the length of the garbage packet need not be of substantial length. The garbage packet may be of any length that will cause an error check (e.g., CRC check) to fail. It may be stated that the security node 340 transmits a signal to cause the unauthorized packet to be corrupted. Throughout this application the term garbage packet may be defined as a data transmission which is sufficient to cause a collision between itself and a packet being broadcast by another node 320. It is not required that the garbage packet comply with any conventional format. In one embodiment, the garbage packet may be a jam sequence.

Furthermore, the CRC check may fail because the node 320 which is broadcasting the unauthorized packet may detect that a collision has taken place and it may stop broadcasting the packet and transmit a jam sequence instead, according to conventional protocol. (The unauthorized node 320 may detect the collision by, for example, detecting excess current on the transmission line.) However, embodiments of the present invention, are not dependent upon the unauthorized node 320 detecting the collision and transmitting the jam signal. Furthermore, the security node 340 may itself transmit a jam sequence, although this is not required. As discussed herein, the garbage packet itself may be a jam sequence.

After broadcasting the garbage packet, the security node 340 again listens for packets being broadcast in the segment 330. Thus, the process 400 returns to step 420. Because it is conventional for a node 320 to perform a backoff/retry protocol after a collision, it may be expected that the unauthorized node 320 may attempt to re-broadcast the packet. As is well understood by those of ordinary skill, the node 320 may attempt to rebroadcast after random time delays. The security node 340 may handle the anticipated re-broadcast of the unauthorized packet in a variety of manners. For example, the security node 340 may simply do nothing until it again detects a packet being broadcast by the unauthorized node 320. Thus, the security node 340 would not perform a backoff/retry protocol, as a conventional device might do. However, embodiments may perform a backoff/retry protocol. In this case, the backoff/retry protocol may follow a conventional sequence (e.g., random time delays), although this is not required. Eventually the unauthorized node 320 may stop re-broadcasting the packet. In this case, communication may return to normal in the segment 330. However, it is possible that the security node 340 repeatedly causes collisions with unauthorized packets, thus effectively stopping communication on the segment 330.

Finally, in optional step 450, the security node 340 sends a warning message that an unauthorized communication is being attempted in the segment 330. In this fashion, further steps may be taken to stop the untrusted node 320 from broadcasting and to return normal operation to the segment 330.

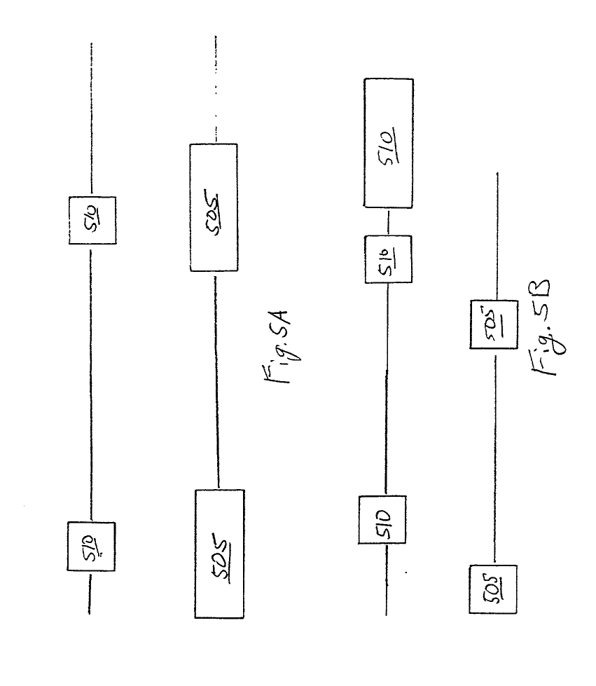

FIG. 5A is a diagram of a timeline showing a possible sequence of events that may occur when a security node 340 detects an unauthorized packet 505 being broadcast. After a short time delay, the security node 340 begins broadcasting the garbage packet 510. After the security node 340 broadcasts the garbage packet 510, it does not attempt to re-broadcast the garbage packet 510, even though a collision occurred. However, the unauthorized node 320 may later rebroadcast the unauthorized packet 505. The security node 340 will then rebroadcast the garbage packet 505.

Referring now to FIG. 5B, in another embodiment, the first time an unauthorized packet is detected, the security node 340 broadcasts the garbage packet 510 to cause a collision. However, in this case, the garbage packet was not broadcast in time to cause a collision. Because the unauthorized node 320 may attempt to repeatedly broadcast short packets, the security node 340 may alter its strategy to increase the chance of a collision. For example, the security node 340 may rebroadcast a garbage packet 510 at pre-determined intervals. The intervals and length of the garbage packet 510 may be strategically selected to reduce the chance that the unauthorized node 320 will have a chance to broadcast. Alternatively, the security node 340 may broadcast a constant jam sequence in this case. While this will effectively shut down all communication in the segment 330, unsecure broadcasts may be prevented until further steps are taken to prevent the unauthorized device from broadcasting.

Therefore, it will be seen that embodiments of the present invention provide for a method to prevent unauthorized access to a network. Embodiments provide a method that works in a network which is vulnerable to attack from a direct connection. Embodiments provide security for devices that are on the same segment of a network.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of providing security a network, said method comprising:
a) detecting a first packet being broadcast in said network, said first packet having associated with it an address that identifies an untrusted device in said network; and
b) in response to said detection, broadcasting a signal to cause said first packet to be corrupted, wherein said first packet is ignored by devices in said network.

2. The method of claim 1, further comprising:
c) re-broadcasting said signal in response to said first packet being detected again.

3. The method of claim 1, further comprising:
c) determining that a collision was not caused by broadcasting said signal; and
d) re-broadcasting said signal according to a predetermined protocol in anticipation of further packets being broadcast from said untrusted device.

4. The method of claim 3, wherein d) comprises:
d1) continually broadcasting said signal, wherein a collision will be caused with any packet broadcast.

5. The method of claim 1, wherein said devices in said network are substantially compliant with the IEEE 802.3 specification.

6. The method of claim 1, wherein said address is a physical address for said untrusted device.

7. The method of claim 1, wherein said address is a Medium Access Control (MAC) address.

8. The method of claim 1, wherein said address is a source Medium Access Control (MAC) address of said first packet.

9. The method of claim 1, wherein said address is a destination Medium Access Control (MAC) address of said first packet.

10. The method of claim 1, wherein said network is an Ethernet.

11. A device for providing security in a network, said device comprising:
memory to store a list of addresses;
detection logic for detecting a first packet that is considered a security risk, said detection based on comparing said list of addresses with an address in said first packet;
logic to transmit a second packet while said first packet is being broadcast, wherein said device is operable to cause a collision between said first packet and said second packet.

12. The device of claim 11 wherein said list of addresses comprises trusted addresses.

13. The device of claim 11 wherein said list of addresses comprises untrusted addresses.

14. The device of claim 11 wherein said detection logic is further for comparing a physical address in said first packet with said list of addresses.

15. The device of claim 14 wherein said physical address is a medium control access (MAC) destination address.

16. The device of claim 14 wherein said physical address is a medium control access (MAC) source address.

17. The device of claim 11 wherein said device further comprises logic operable to transmit a warning message if a packet having an untrusted address is detected.

18. The device of claim 11 wherein said device is selected from the group comprising: a router, a switch, and a network interface card (NIC).

19. A method for providing security in a segment of a network, said method comprising:
a) determining that a first packet broadcast in said segment is associated with an untrusted node; and
b) broadcasting a second packet to cause a collision between said first packet and said second packet, wherein nodes in said network ignore said first packet.

20. The method of claim 19, wherein a) comprises:
a1) reading an address in said first packet, said first packet received at a first node; and
a2) determining that said address is on a list stored on said first node, said list comprising unauthorized addresses, wherein said first packet is determined to be associated with said untrusted node if said address is on said list.

21. The method of claim 20 further comprising:
c) adding to said list of unauthorized addresses an unauthorized address.

22. The method of claim 19, wherein a) comprises:
a1) reading an address in said first packet, said first packet received at a first node, said list comprising authorized addresses; and
a2) determining that said address is on a list stored on said first node, wherein said first packet is determined to be associated with said untrusted node if said address is not on said list.

23. The method of claim 22 further comprising:
c) adding to a list of authorized addresses an authorized address.

24. The method of claim 19, further comprising:
c) determining that a third packet broadcast in said segment is associated with said untrusted node; and
d) broadcasting a fourth packet to cause a collision between a said third packet and said fourth packet, wherein nodes in said segment ignore said third packet.
